(19) United States
(12) Patent Application Publication
(10) Pub. No.: US 2026/0029270 A1
(43) Pub. Date: Jan. 29, 2026

(54) CONTACTLESS FLUID MONITORING SYSTEM

(71) Applicants: John McKeeman, Wellington, FL (US); Stuart Partin, Margate, FL (US); Michael McConkey, LaFollette, TN (US)

(72) Inventors: John McKeeman, Wellington, FL (US); Stuart Partin, Margate, FL (US); Michael McConkey, LaFollette, TN (US)

(21) Appl. No.: 19/281,604

(22) Filed: Jul. 26, 2025

Related U.S. Application Data
(60) Provisional application No. 63/675,940, filed on Jul. 26, 2024.

(51) Int. Cl. G01F 23/2962; G01C 9/06; G01F 23/296; G01K 1/024

(52) U.S. Cl. CPC G01F 23/2962; G01C 9/06; G01F 23/2968; G01K 1/024

(57) ABSTRACT

A contactless fluid monitoring system uses a bung with an ultrasound transceiver to measure the headspace in a wine cask or similar container. Ultrasound signals are transmitted through an elongated waveguide so that the signal is in the form of a beam. The elongated transmission waveguide obstructs undesirable intrusion of material into the bung, and filters echo reflections from the ultrasound transceiver so that it receives signals from the same direction at which they are sent. A processor in the bung uses the ultrasound transceiver data, and inclinometer and predetermined information to calculate the headspace within a wine cask. A data collector may wirelessly receive information from a plurality of fluid monitoring bungs and compile and process the data for further analysis.

### CROSS-REFERENCE TO RELATED APPLICATIONS

This application claims priority to U.S. Provisional Application Ser. No. 63/675,940 filed on Jul. 26, 2024.

### STATEMENT REGARDING FEDERALLY SPONSORED RESEARCH OR DEVELOPMENT

### Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

### Field of the Invention

The present invention relates to systems for measuring the fluid level in a container. More particularly, the invention relates to a bung having a directed ultrasonic transducer for measuring the distance to the surface of a liquid in a container and is connected to a wireless network.

### Description of the Related Art

Wine and other alcoholic beverages are aged in oak barrels to increase the flavor and quality. During this aging process, wine evaporates slowly through the oak wood, gradually lowering the wine level within the barrel. Additionally, small imperfections in barrels can lead to slow leaking, causing headspace to increase unpredictably. Wine benefits from the micro-oxidation process that occurs through the porous organic structure of the oak wood. However, excess amounts of oxygen are potentially damaging to the wine. As the level of wine lowers within an oak barrel, the space that fills up with air is known as the barrel head space. Winemakers periodically check the level of contents of the barrel, topping up the barrel with additional wine or whiskey to reduce headspace and the destructive effect of oxygen to wine.

The common practice in the wine industry is to use a random sampling of barrels to identify abnormal aging conditions, such as oxidation, abnormal sulfite levels, fluid loss, and other issues. The current method for monitoring wine barrel conditions and fluid level is a manual process where a technician visually looks into a barrel and logs temperature and headspace. Unfortunately, such random sampling causes ambient oxygen to enter a cask, with deleterious consequences for the wine.

Other industries also involve measuring the level of a liquid in a container. There are several techniques for determining the fill level, which can be split in two main categories depending on whether the sensing element is in contact with the substance or not. Non-intrusive and non-contact techniques have several advantages, notably in terms of contamination and maintenance. Radar and ultrasonic technologies are generally involved in non-contact level measurement. However, both of these technologies are susceptible to false echoes.

Optical level measurement is another non-contact technique. This technique uses a light beam which is directed to the top surface of the liquid or material and reflected back to an optical sensor. For liquid level measurement, a floatable reflector is often used to improve the performance. Some optical methods use the speed of light to determine the distance between the sensor and the surface. One of such methods is based on the time of flight principle using short pulses of light generated by a laser.

Ultrasonic level detectors generally determine the level of the liquid or material by using a transducer to generate a burst of ultrasonic energy towards the surface to be detected. The energy burst is reflected by the surface and the reflected echo is detected by the transducer. The level of the surface within the tank is determined based upon the amount of time required for the energy burst to travel from the transducer to the surface and back. While the operation of such a detector is simple in concept, various practical problems arise in the implementation of such devices. One such problem involves the reception by the transducer of multiple echoes of the burst of energy or echoes from the internal structure of the container, such as internal pipes, for example.

One attempt to remedy this involves the use of a timed “receive window” of a variable size. In order for the system to recognize an echo signal as one that corresponds to the surface being located, the echo signal must be detected within the receive window. Another method of using ultrasound sends bursts of sonic energy through both the wall of the container and the liquid in the container. The walls of the container may be of various materials, such as steel or plastic for example, and may have various thicknesses. The amount by which the sonic energy is attenuated depends upon both the wall material and thickness. The liquid within the container may also contribute a varying degree of attenuation since different liquids may have different attenuation coefficients. This requires complex software and calibration of individual casks to operate accurately. Thus, the initial set up is cumbersome, time consuming, and must be re-evaluated periodically.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide a non-intrusive, contactless system for accurately measuring the level of a fluid in a container, such as measuring the level of wine in an aging cask, that is accurate, reliable and easy to install.

### BRIEF SUMMARY OF THE INVENTION

Disclosed is a contactless fluid measuring system that measures air gap levels in a collection of sealed containers without contacting the fluid inside the container. In one embodiment, a contactless fluid monitoring system uses a bung having an elastic body having a top, bottom, and an internal cavity. The bung also includes a processor housed within the internal cavity of the bung, a liquid level sensor in communication with the processor and directed toward the bottom of the bung. A transmission waveguide extends from the liquid level sensor to an opening in the bottom of the bung. The bung measures the unfilled portion of a container by reflecting ultrasound energy off the surface of a liquid in the container and transmit this data to a collector which may then store the data on a server. The liquid level sensor may be an ultrasound transceiver, and the processor may include an inclinometer, a temperature sensor, a fuel gauge, a battery and a wireless charging module.

It is therefore an object of the present invention to provide a bung for use in wine casks and other containers to measure the headspace, i.e. how full the container is.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a side perspective view of a bung for a contactless fluid monitoring system in accordance with principles of the invention;

FIG. 2 is a side view of a bung body for a contactless fluid monitoring system in accordance with principles of the invention;

FIG. 3 is a bottom view of a bung body for a contactless fluid monitoring system in accordance with principles of the invention;

FIG. 4 is a top view of a bung body for a contactless fluid monitoring system in accordance with principles of the invention;

FIG. 5 is a top perspective view of a partially opened bung for a contactless fluid monitoring system in accordance with the principles of the invention;

FIG. 6 is a top view of a PCB for a bung for a contactless fluid monitoring system in accordance with principles of the invention;

FIG. 7 is a bottom perspective view of a PCB for a bung for a contactless fluid monitoring system in accordance with principles of the invention;

FIG. 8 is an exploded view of a bung for a contactless fluid monitoring system in accordance with the principles of the invention;

FIG. 9 is a top view of a bung with the lid removed for a contactless fluid monitoring system in accordance with principles of the invention;

FIG. 10 is a top view of a fully assembled bung for a contactless fluid monitoring system in accordance with principles of the invention;

FIG. 11 is a cross-sectional view of a cask having a bung for a contactless fluid monitoring system in accordance with principles of the invention;

FIG. 12 is a diagrammatic representation of a contactless fluid monitoring system in accordance with principles of the invention;

FIG. 13 is a flowchart of programming for a controller for a bung for a contactless fluid monitoring system in accordance with principles of the invention;

FIG. 14 is a flowchart of a BLE Gateway for transmitting information from a bung of a contactless fluid monitoring system in accordance with principles of the invention;

FIG. 15 is a flowchart for a Dashboard Server for a contactless fluid monitoring system in accordance with principles of the invention.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein. Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

Unless otherwise indicated, all numbers expressing quantities of ingredients, dimensions, reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

Various embodiments of the disclosure could also include permutations of the various elements recited in the claims as if each dependent claim was a multiple dependent claim incorporating the limitations of each of the preceding dependent claims as well as the independent claims. That is, the combinations of the various components of the invention are not limited to those combinations expressly shown in the Figures. Unless expressly stated otherwise, components described in one embodiment may be interchanged with components of the same name found in other embodiments. Such permutations are expressly within the scope of this disclosure.

Disclosed is a non-contact fluid monitoring system that measures fluid levels in sealed containers without contacting the fluid inside the container. Examples of fluids that may be monitored include wine in casks, spirits in casks, gasoline in tanks and wastewater in septic tanks. The fluid level and other data are then transmitted through a wireless network.

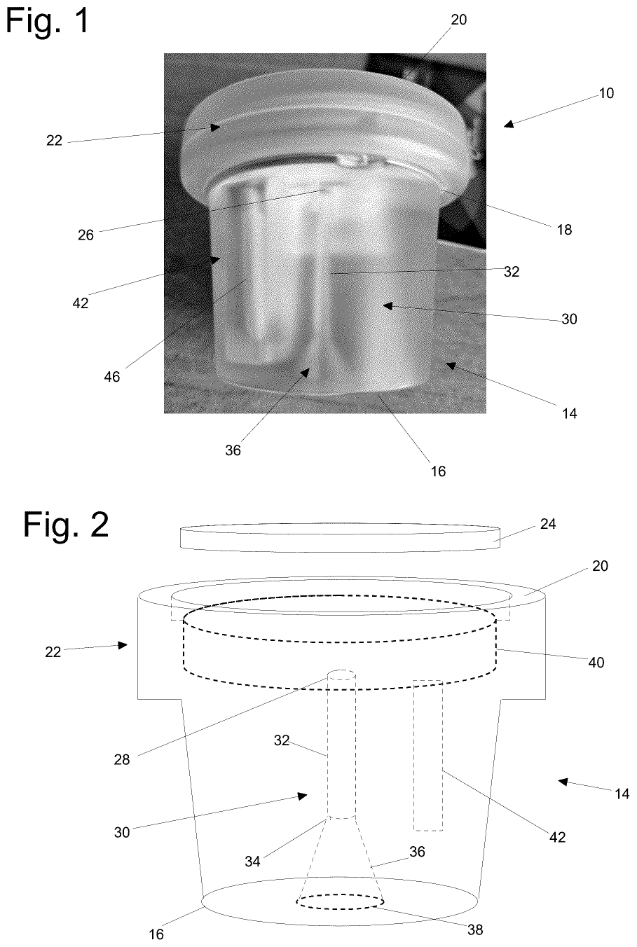

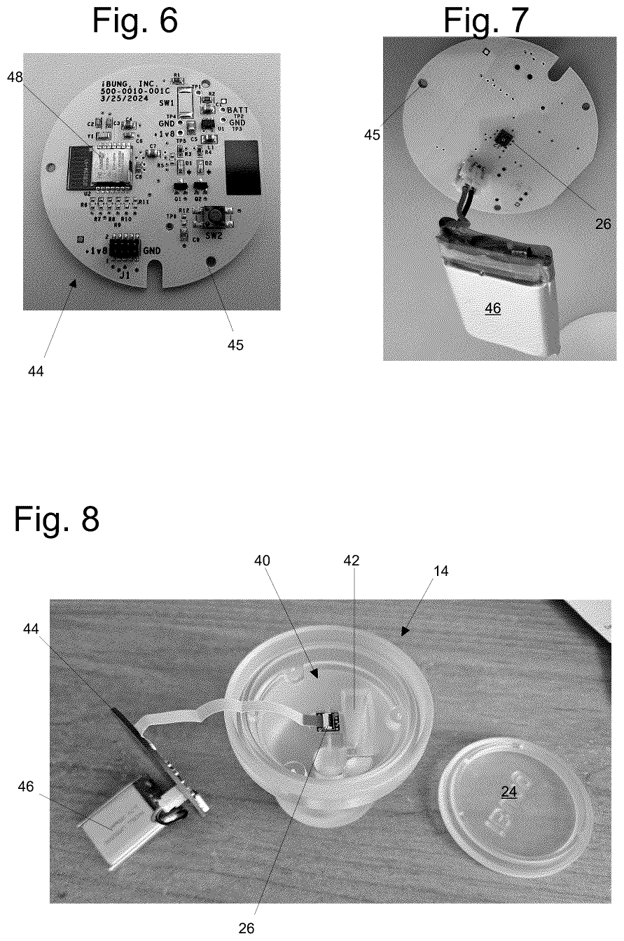

FIGS. 1-10 show an exemplary bung 10 in accordance with principles of the invention. The bung 10 has an elastic, a substantially cylindrical body 14, shown particularly in FIGS. 2-4. The body 14 has a slight downward taper such that it is frustoconical, with a flat circular bottom 16 that has a smaller radius than at the shoulder 18 just below a cylindrical cap 22 extending between the shoulder 18 and a circular top 20. When the bung 10 is inserted into a bunghole in a cask, the external cap 22 remains outside the cask. In use, the body 14 below the cap 22 extends into a cask and forms a friction fit with the bunghole into which it is inserted. The bung 10 is at least partially formed from an elastic material such as rubber, silicone, cork, an elastomer, or the like. The bung body 14 includes one or more internal cavities accessible by removing a top lid 24. In this embodiment, the body 14 includes an upper cylindrical cavity 40 for housing electronic circuitry and an ultrasound transceiver, and a lateral cavity 42 for housing a battery 46, as explained more fully below.

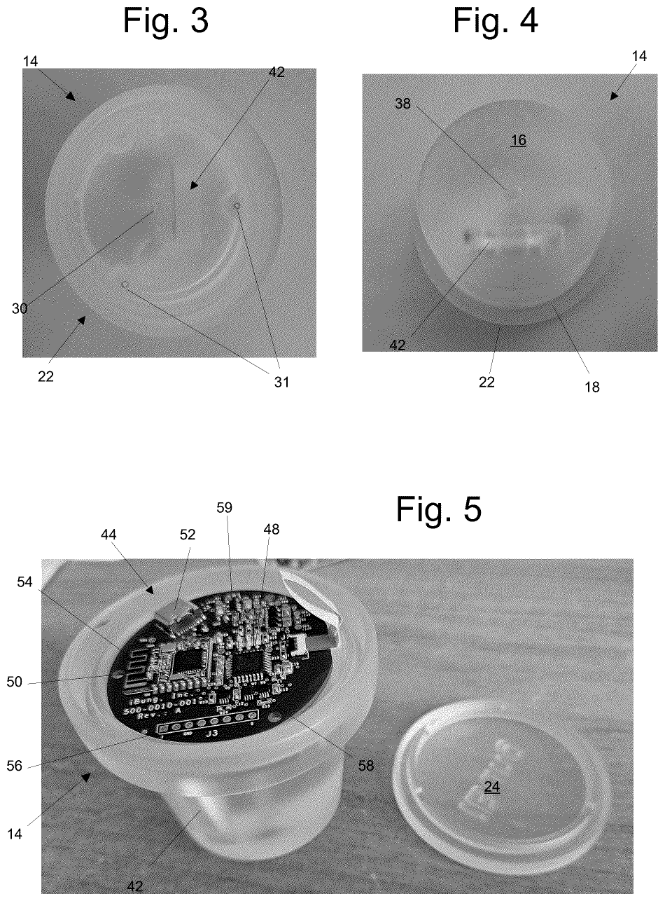

The bung body 14 includes an ultrasound transmission waveguide 30. In this embodiment, the transmission waveguide 30 has a substantially circular cross-section, but may optionally have other configurations. The transmission waveguide 30 is centered over and aligned with the ultrasound transceiver 26 (shown in FIG. 8). Transmission waveguide 30 tapers outward as it goes down. In this embodiment, the transmission waveguide includes an internal region 32 that tapers outward only slightly and is substantially cylindrical. Central region 32 of the waveguide 30 is 3 to 4 mm in diameter at its widest point 34, where it intersects the bottom region 36 of the waveguide 30 which tapers more rapidly such that it is substantially cone shaped and forms a hole 38 in the center of the bottom 16 of the bung 10. The bung body 14 of this embodiment includes two internal cavities 40 and 42, for retaining a printed circuit board (PCB) 44 and a battery 46, respectively. The battery 46 may be detachable from the PCB 44 and may be rechargeable. Optionally, the PCB 44 may be connected to a direct power source, but it may be generally preferred to utilize a local power source. In this embodiment, the body 14 is partially opaque. Optionally, the body 14 may be substantially transparent, or may be completely opaque so that its internal components are not visible. Referring to FIG. 3, the body 14 of this embodiment includes three screw-holes 31 in the cavity 40 for securing a circuit board in the cavity. Another advantage of the waveguide 30 is that it naturally forms an air bubble when the liquid surface is above the bottom 16 of the bung. This allows the bung to operate and take measurements even when the liquid rises above the level of the bung's bottom. It also prevents the electronic components from being immersed in liquid and damaged or destroyed.

FIGS. 5-9 show the internal components of the bung 10. FIG. 5 shows the bung 10 with the lid 24 removed from the cap 22 so that the printed circuit board (PCB) 44 is visible inside the cavity 40. Those skilled in the art will appreciate that the PCB 44 includes a Bluetooth® transmitter and microprocessor 48 and optionally may include a variety of modules, such as for example an inclinometer 50 for measuring the angle at which ultrasound transmissions travel through the transmission waveguide 30, a GPS module 52 for identifying the location of the bung 10, a fuel gauge 58 for determining when the battery 46 or other power source may need to be replaced or replenished. The PCB 44 may also optionally include a temperature gauge 56 for measuring the temperature inside and/or outside a cask. The PCB 44 also includes a wireless communication module 54 for interacting with a wireless network, and a port for attaching an electronic device for programming the PCB 44. Optionally, the bung 10 may also include one or more LED lights for indicating whether the bung 10 is powered on, transmitting signals, and to provide feedback as the PCB is being programmed. The wireless communication module 54 may be, for example a Bluetooth® transceiver or a wireless modem. It may also transmit data via radio frequency or other means. The PCB 44 also includes three screw-holes 45 for securing the PCB 44 within the cavity 40, as shown below.

FIG. 8 shows the internal components partially inserted into the body 14 of the bung 10. The ultrasound transceiver 26 placed directly above the transmission waveguide 30, underneath the PCB 44. The ultrasound transceiver 26 may be affixed to the bottom of the PCB as shown in FIG. 7, or may be a separate component as shown in FIG. 8. When the transceiver 26 is affixed to the PCB 44, it is generally preferred to use screw-holes to secure the PCB in place within the cavity to ensure that the transceiver is properly aligned with the transmission waveguide 30. Optionally, adhesive may also be included, or may be used in place of screws.

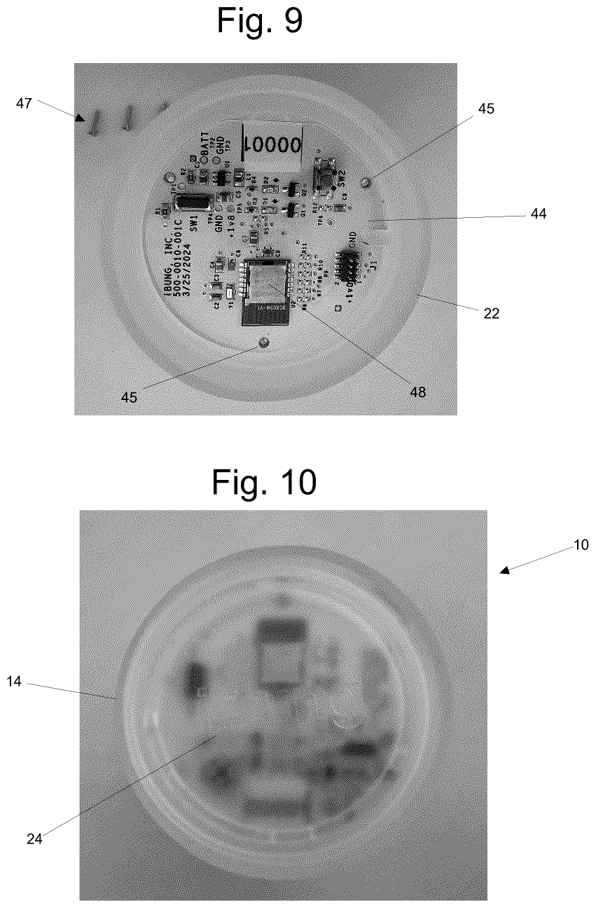

FIG. 9 shows the PCB 44 inserted into the cavity 40 in the body 14 with the screw-holes 45 in the PCB 44 aligned with the screw-holes 31 in the cavity 40. Screws 47 are then inserted to secure the internal components in place and in a correct orientation. FIG. 10 shows the bung 10 fully assembled with the lid 24 covering the cavity 40 and PCB 44.

The contactless fluid monitoring system, e.g. the bung 10, measures air gap levels, or headspace, in a collection of sealed containers without contacting the fluid inside the container. This monitoring system may be used in, but is not limited to, the wine industry where it is desired to minimize or eliminate the amount of air above the wine in the wine cask. The system is designed to report the amount of air gap within the cask so that the user may refill the cask. Refilling the cask reduces the amount of surface area of wine that is exposed to air, thereby reducing oxidation of the wine and improving the quality. The system does not measure the amount of liquid in the cask. Rather it measures the air gap distance from the bottom of the device to the fluid top without contacting the fluid. The device can be used for measuring the amount of fluid and/or fluid levels for a variety of fluids in a variety of situations. Examples of other fluids that may be monitored include spirits in casks, gasoline in tanks and wastewater in septic tanks. The air gap levels from multiple containers are collected by a centralized hub or collector. The communication between the electronic sensor device and collector unit is via a radio frequency link (RF). The collector then makes the collected data available to the user from a cloud server.

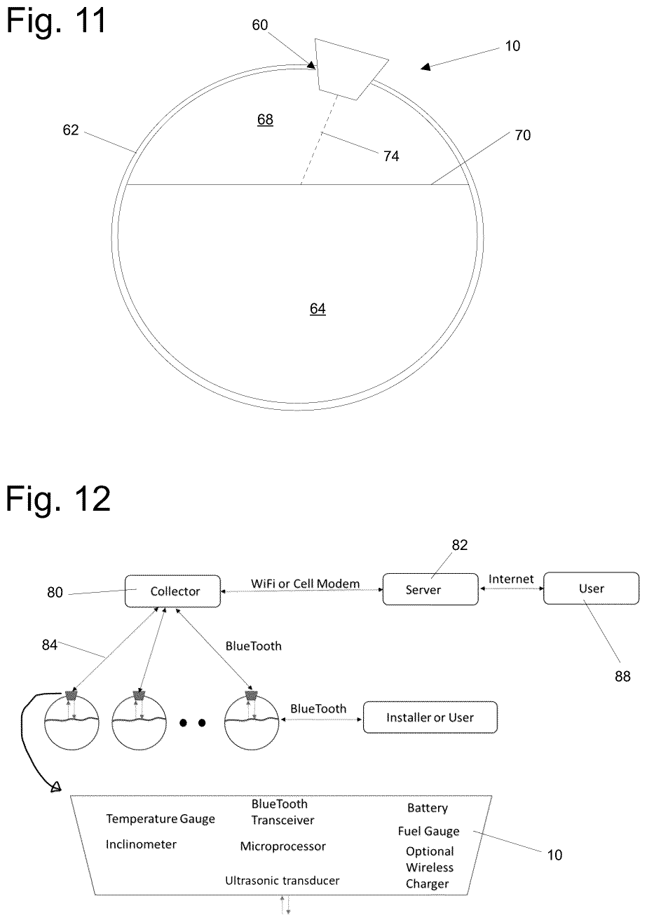

FIG. 11 shows a bung 10 inserted into a bunghole 60 of a cask 62 in accordance with the principles of the invention. The cask 62 is filled with wine 64 which defines a headspace 68 between the surface 70 of the wine 64 and the top of the cask 72. The bung 10 sends an ultrasound signal 74 which reflects off the surface 70 of the wine 64. The transmission waveguide blocks echoes of the ultrasound transmission so that the bung 10 only receives and records a signal along the same path in an opposite direction to the signal 74 it sent. The PCB measures the distance from the bung to the surface 70 of the wine 64 and uses data from its inclinometer to calculate the total distance from the top of the cask 62 to the surface 70, and uses this to calculate the total headspace 68. This allows the bung 10 to accurately detect the true headspace 68 in the cask even when the bunghole 60 is not perfectly vertically aligned.

Ultrasound is generally the preferred type of energy used to generate a signal to reflect off a liquid surface. Other types of signals, such as electromagnetic waves, may also be used to send a signal that is reflected off the surface of the liquid. Regardless of which type of energy use used to generate the signal, the signal may take the form of a pulse or burst of a specific wavelength. Optionally, multiple wavelengths may be used to generate multiple pulses for a single signal to be emitted, reflected and detected.

FIG. 12 shows the system comprises one or more remote measuring units, i.e. the bungs 10, a collector 80, and a server 82. The remote measuring units, i.e. the bung 10, measures the air gap levels using the ultrasound transceiver within a container and the frequency of measurement may be wirelessly programmed into the bung's PCB, either wirelessly or by physically attaching an electronic device to each PCB. For instance, if the period is set for once per day, the bung will “wake up” every 24 hours, measure the air gap level, and any other information such as temperature, and send 84 this data to the collector 80. Other data, such as remaining battery life, temperature, etc., may also be transmitted. Data from each bung in the system is transmitted to the collector via a Bluetooth® link, radio, or the like. A single collector 80 may receive data from as many as 400 bungs or more. Multiple collectors 80 may be used for larger numbers of bungs. Data from the collector 80 is then transmitted to the cloud via a WiFi, ethernet link or a cell modem. The user 88 can access the data through a web interface.

For example, the monitoring system of the invention may be used in a cask room containing as many as 1,000 casks. Each cask has a bung 10 inserted into its bunghole. The bungs wirelessly transmit their data through one or more collection hubs. The collectors 80 transmit their data in real time through the cloud to the server 82.

The ultrasound transceiver module may require a minimum distance, e.g. 40 mm, between it and the object to be measured. The bung 10 and the length of the waveguide may be configured to ensure that the minimum distance is achieved. Generally, ultrasound transceivers have a wide angle field of view, nearly 180 degrees, which results in a very high density of echoes within the headspace of a cask. The waveguide facilitates forming an ultrasound signal into a narrow beam directly below the bung. The material from which the bung 10 is formed is preferably both compatible with the wine making industry and has acoustic properties which allow the waveguide to form a signal as a directional tight beam of ultrasound energy and a color and/or opacity to eliminate any light from entering the cask that might taint the wine.

After processing the air gap data, the bung 10 broadcasts a data packet to the collector. The collector may further process the data, such as for example appending date and time stamps, and/or the identity of the cask to the data from the bung. These data may then transmitted through the cloud and stored on a data server 82. The server 82 then processes the data, and attends any other data, e.g. the barrel room location and cask number. The string of the barrel room, cask number, date, time and air gap, and any other data, may then be posted on the server's website. If the headspace data is below a preset maximum distance, the bung may return to a sleep mode to preserve power. The bung may stay in sleep mode for up to 24 hours before waking up to take another measurement. If the measured headspace is below a predetermined minimum, the bung 10 may include that data, as well as any alerts, with the data it transmits to a collector. If the air gap is equal to or above a preset maximum distance, the bung may also intermittently flash a red LED for one minute then enter deep sleep mode for one hour. The bung may then wake up to take a measurement. If the measurement is still equal to or above a preset maximum distance, the bung broadcasts this information and again flashes the red LED for one minute and reenters deep sleep mode. The server may transmit a message to the cask owner alerting them of the cask that requires refilling. The bung may continue in this mode until the cask is refilled.

Optionally, the PCB inside the bung may be built with a highly reflective white solder mask to reflect the largest amount of LED light possible through the top or lid of the bung. The top of the bung may optionally clear to allow the LED to shine through the top and is also designed to maximize viewing angle allowing the user to easily identify the cask that requires refilling through the blinking red LED.

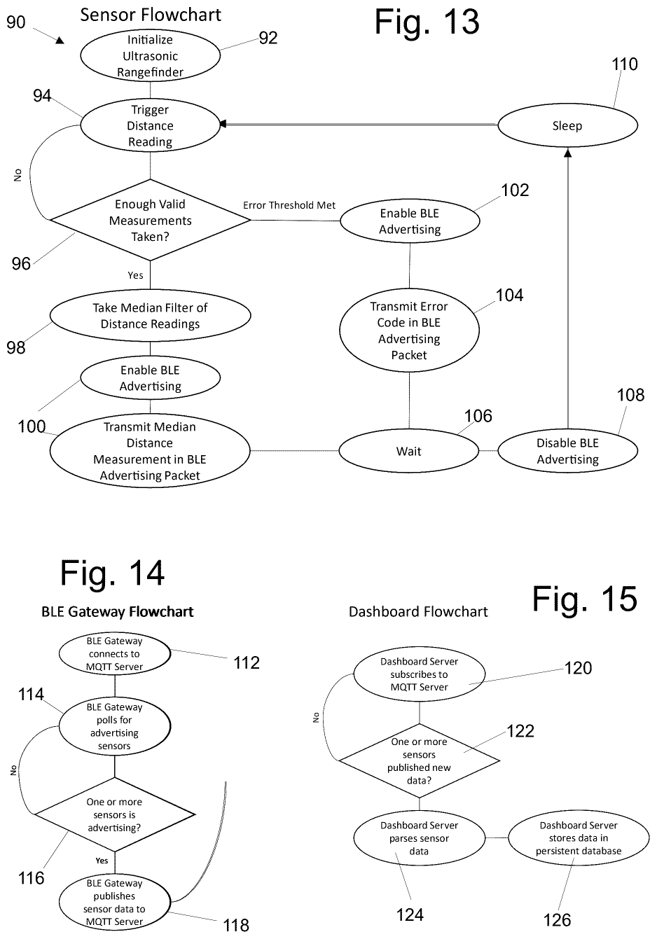

FIG. 13 is a flowchart 90 illustrating an exemplary programming of a controller and a bung in accordance with the principles of the invention. In the first step 92, the system is initialized by programming various predetermined parameters. The ultrasonic transceiver does not have any persistent memory, and must be written with manufacturer-provided firmware on every power cycle. This step loads short-range, narrow Field of View firmware into the transceiver, initializes its RAM, calibrates its internal clock, and configures it to use a minimum range of 40 mm, a maximum range of 80 mm, and to only take readings when explicitly triggered.

Next, the device is triggered to take a distance reading in step 94. The microcontroller sends a signal to the ultrasonic transceiver to take a single distance reading. The rangefinder automatically processes the time of flight, returning a distance reading and any error codes encountered. This process is repeated as shown in step 96 until either a) 32 readings report an error, typically a NO TARGET error indicating that the transceiver did not detect a strong enough echo pulse; or b) 16 readings are taken that fall within a configured range, without a reported error. This is one of many different methods for ensuring that the device is operating properly, or at least consistently. The configured range is typically predetermined, and can be based on methodical calibrations of the device or optionally by selecting parameters in the programming, such as container size, liquid composition and the like.

In this embodiment, the controller in the bung itself performs some simple data analysis tasks. In steps 98-100, if a sufficient, predetermined number of reliable measurements are taken, the device then calculates the median reading value. In step 100, the bung transmits its data using Bluetooth Low Energy (BLE) Advertising. Alternatively, if the number of reliable measurements, as calculated by the controller in the bung, does not meet or exceed a predetermined minimum number, then the bung will proceed along alternate steps 102 and 104, where it again enables BLE Advertising, but transmits the error codes instead of the readings.

This data is passively transmitted. A collector does not need to explicitly pair to a BLE device to read this data. There is no mechanism used to confirm that a collector has read the data. The BLE antenna also has a constant manufacturer-provided MAC Address used as a permanent ID for each sensor. The transmitted data can include an identifier for a particular bung, the median reading value, and any error codes generated while the measurements were being taken. The information may also include the temperature of the bung and readings from the inclinometer. Temperature and inclination may be used directly by the controller in the bung to calculate the volume of liquid in the container. However, those skilled in the art may appreciate that it is just as easy or possibly easier for the bungs to simply transmit the information their sensors detect and allow an operator and/or software at a central station to use that information to determine the amount of liquid in each of the containers. This would avoid requiring operators to input specific directions and instructions for each individual bung. All of the information could be entered from a single location. Optionally, the bung could simply transmit all of its data from its measurements and allow a remote location to calculate the median measurement value, and perform statistical analysis on the actual measurements, including error codes and Q testing for outliers, and the like.

Once the bung has transmitted either the reading or the error codes, the bung continues transmitting for one minute, step 106, before shutting back down, step 108, and sleeping for another 24 hours, step 110. One step 110 is completed, the bung cycles back to step 94, where a reading is triggered and the cycle repeats.

FIG. 14 illustrates the incorporation of a BLE Gateway to collect the data from a network of bungs and transmit it over the internet. The BLE Gateway is a device that is connected to the Internet via ethernet or Wi-Fi. In step 112, the BLE Gateway connects to an MQTT server. This step registers the collector with an MQTT broker to allow it to push data to the cloud. MQTT is an IOT-focused protocol which allows remote devices to publish live data to subscribing clients. Next, in step 114 the BLE Gateway polls for advertising sensors. The BLE Gateway uses an onboard BLE antenna and is continuously scanning for nearby BLE devices. In step 116, the BLE Gateway determines whether one or more sensors is advertising. The collector is configured to filter out all BLE devices that do not match the expected Device Name. Finally, in step 118, the BLE Gateway publishes any acquired sensor data to MQTT Server. At the end of a polling period, the BLE Gateway collates data from all nearby sensors and pushes this data to the MQTT Server. This data may include the full BLE advertising packet in addition to the Gateway's MAC address, a timestamp of when the sensor was detected, and the signal strength between the Sensor and the Gateway. The system then returns to periodic polling for advertising.

FIG. 15 illustrates an exemplary flowchart for a dashboard in accordance with the principles of the invention. In step 120, a Dashboard Server subscribes to MQTT Server, i.e. the Dashboard server connects to the MQTT broker. In step 122, the dashboard software checks whether one or more bungs has published new data, and is notified when a BLE Gateway publishes new data to the MQTT Server. When data is received, the Dashboard Server continues to step 124 and parses the sensor data, i.e. the raw bytes in advertising packet. The software may also perform additional operations on the Raw data. For example, it may subtracts out the 40 mm (or other amount based on the length of the waveguide in the bung) gap from the reported headspace measurement, to account for the waveguide length. Optionally, the Dashboard Server may converts sensor MAC addresses to a user-friendly cask ID, filters out repeat data, and other data processing. In step 126, the Dashboard Server stores data in persistent database. The Dashboard Server is then able to display the latest headspace for all sensors on the frontend, alert a user if the headspace is beyond a threshold, and display historical data for all sensors, and perform other tasks.

Because the entire sensor system is contained within the bung, it may readily be used to measure liquid levels of almost any type of liquid in almost any type of container, by simply placing the bung in an opening of the container. The waveguide advantageously also serves to protect the internal components of the bung even when the liquid in a container rises above the level of the bung itself, or when the liquid is disturbed and splashes. The invention also may be used while the container is kept air tight, and does not require a component that comes into physical contact with the liquid. It is substantially easier to use than transducer methods applied outside the container.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. Descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A contactless fluid monitoring system comprising:
a bung having an elastic body having a top, bottom, and an internal cavity, wherein the bung is inserted into a bunghole in a top half of a container such that the bottom of the bung faces an inside of the container and the top of the bung faces an outside the container;
a processor housed within the internal cavity of the bung;
a liquid level sensor in communication with the processor and directed toward the bottom of the bung;
a transmission waveguide extending from the liquid level sensor to an opening in the bottom of the bung;
wherein the liquid level sensor measures an amount of liquid in the container by emitting a signal through the transmission waveguide and measuring a return signal reflected off a surface of a liquid in the container.

2. The contactless fluid monitoring system of claim 1 wherein the liquid level sensor is an ultrasound transceiver and the emitted signal is a pulse of ultrasound energy.

3. The contactless fluid monitoring system of claim 2 wherein the processor is in communication with a wireless network.

4. The contactless fluid monitoring system of claim 3 wherein the processor includes an inclinometer.

5. The contactless fluid monitoring system of claim 4 wherein the bung further comprises a temperature gauge, a battery and a wireless charging module.

6. The contactless fluid monitoring system of claim 5 wherein the transmission directing waveguide is cylindrical and tapers outward near the hole in the bottom of the bung.

7. The contactless fluid monitoring system of claim 6 wherein the bung has an external cap region forming a shoulder with a frusto-conical plug region, the plug region being configured to form a hermetically sealing friction fit with a bunghole.

8. The contactless fluid monitoring system of claim 7 wherein the signal comprises a plurality of ultrasound pulses have different frequencies.
